(19) United States
(12) Patent Application Publication
(10) Pub. No.: US 2003/0123431 A1
(43) Pub. Date: Jul. 3, 2003

(54) Methods and apparatus for providing internet messaging on the screen of a digital telephone

(76) Inventors: Bertram Geck, Boca Raton, FL (US); Francisco Olympio Marcon da Rocha, Boca Raton, FL (US)

Correspondence Address: Siemens Corporation, Intellectual Property Department, 186 Wood Avenue South, Iselin, NJ, 08830, US

(21) Appl. No.: 10/034,395

(22) Filed: Dec. 28, 2001

(51) Int. Cl. G06F 15/16

(52) U.S. Cl. 370/352; 370/353

(57) ABSTRACT

Methods and apparatus for redirecting Internet-type text messages from a computer workstation to a digital telephone having an LCD display include replacing Internet browser plug-ins with applications which intercept messages and redirect them to the digital telephone. The applications also permit the digital telephone to log on to the workstation and identify the address of the telephone so that messages may be forwarded to the correct address.

### BACKGROUND OF THE INVENTION

1. Field of the Invention

The invention relates to digital telephony. More particularly, the invention relates to methods and apparatus for routing internet messages for display on the screen of a digital telephone.

2. Brief Description of the Prior Art

The modern office environment includes data and telephone networks. As illustrated in FIG. 1, employees typically have both a telephone 10 and a computer workstation 12 on their desk. Often the telephone 10 is a modern digital telephone which includes a relatively large LCD display 14 for displaying the date and time and call information when the phone is in use.

Computer workstations were originally provided for data input and retrieval, document creation, etc. Today, however, computer workstations are used for communication. Electronic mail and instant messaging are common in most offices today. One of the disadvantages of electronic mail and instant messages is that they can interfere with an employee's other work. For example, as shown in FIG. 1, an instant message 16 may pop up on an employee's screen obscuring the document 18 the employee was reading, creating or editing. This kind of interruption can adversely affect productivity. Similarly, electronic mail delivery calls the attention of an employee with a flashing icon and an audible sound. This tempts the employee to stop working and immediately check the electronic mail. Unless the mail concerns an urgent matter, this distraction also adversely affects productivity. Still another disadvantage of electronic mail and particularly instant messages is that there is usually no simple way of forwarding them to a different location. Unlike telephone calls which are easily redirected from one device to another device almost anywhere in the world, it is not as simple to redirect an instant message to, e.g., a wireless device.

### SUMMARY OF THE INVENTION

It is therefore an object of the invention to provide methods and apparatus for preventing electronic mail and instant messages from interrupting an employee's work.

It is also an object of the invention to provide methods and apparatus for redirecting electronic mail and instant messages from a computer workstation to another digital device.

It is another object of the invention to provide methods and apparatus for utilizing the LCD display of a digital telephone when it is not being used to display call information.

It is yet another object of the invention to provide methods and apparatus for redirecting virtually any Internet data from a computer workstation to another digital device.

It is another object of the invention to provide methods and apparatus whereby Internet data can be redirected from a computer workstation to a digital device anywhere in the world.

In accord with these objects which will be discussed in detail below, the apparatus of the invention includes at least one digital telephone coupled to the Internet, a computer workstation coupled to the Internet, and an application program which redirects data received by the computer workstation to the display of the digital telephone.

According to one embodiment, a computer workstation is coupled to the Internet and to a TCP/IP LAN and a digital telephone having an LCD display is coupled to a local PBX and to the TCP/IP LAN. The computer workstation is provided with an Internet browser and an application that replaces the plug-in provided by the browser's vendor to handle the messaging features. The application uses the same port designated to the original browser plug-in. In addition to the normal features of the original plug-in, two new features are provided: the capability to login at the digital telephone and the capability to resend the messaging service information packets to the digital telephone, after adding the digital phone addressing (received during login) to the original message.

According to a second embodiment, a computer workstation is connected to the Internet and a digital telephone having an LCD display is connected to a local PBX. The local PBX is connected to a server computer which is connected to the Internet and which provides Internet access over the PBX via a proprietary interface. The computer workstation is provided with an Internet browser and an application that replaces the plug-in provided by the browser's vendor to handle the messaging features. The application uses the same port designated to the original browser plug-in. In addition to the normal features of the original plug-in, two new features are provided: the capability to login at the digital telephone via the PBX and the capability to resend the messaging service information packets to the digital telephone, after adding the digital phone addressing (received during login) to the original message.

In both embodiments, the PBX “forwarding” feature can be applied to the messages displayed on the digital telephone's LCD display. Thus, Internet messages can be forwarded to any telephone or digital device connected to the PSTN anywhere in the world. Messages are forwarded via a “message mail” similar to the existing “voice mail”.

An exemplary embodiment of the invention employs the Siemens Hicom™ 150 AllServe™ PBX hub. The Hicom™ 150 includes a LAN card for coupling the PBX to a TCP/IP LAN. A new application is installed in the Hicom™ 150 LAN card to receive TCP/IP packets related to the messaging service, decode and format the messages and send them to the corresponding Call Processing User Interface for delivery to LCD equipped digital telephones coupled to the PBX. The PBX Call Processing User Interface is enhanced to support the messaging service login procedure and to administer the display content presentation. This embodiment allows the Hicom™ 150 AllServe™ users to have access to Internet messaging services regardless of where they are actually located, as long as they are connected directly to the Hicom™ 150 AllServe™ in any of the networked corporate facilities or connected remotely to the Hicom™ 150 AllServe™ via its fixed or mobile tele-working features.

### BRIEF DESCRIPTION OF THE DRAWINGS

FIG. 1 is a high level diagram illustrating a state of the art digital telephone with an LCD display and a computer workstation having internet access;

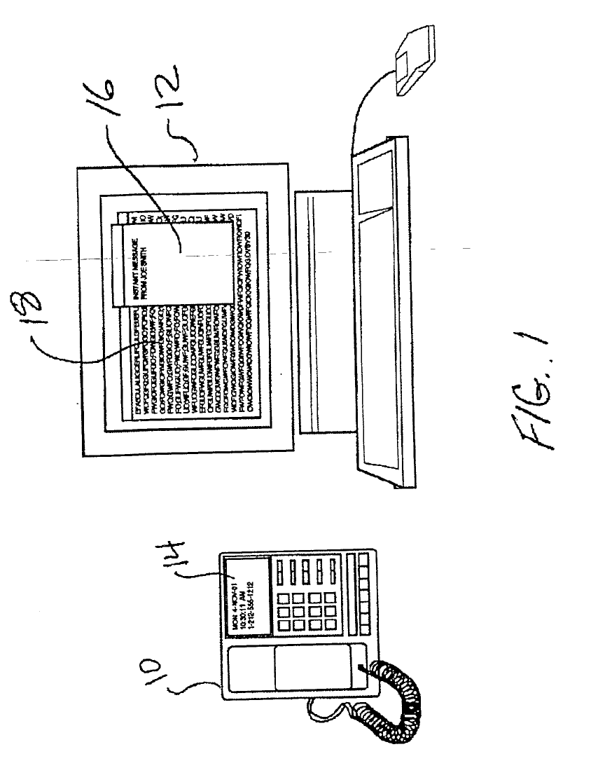

FIG. 2 is a high level diagram illustrating a first embodiment of the invention for rerouting Internet messaging services from the computer workstation to the digital telephone;

FIG. 3 is a high level block diagram illustrating a second embodiment of the invention for rerouting Internet messaging services from the computer workstation to the digital telephone via a server computer connected to a TCO/IP network and to the PBX;

FIG. 4 is a high level block diagram illustrating the software modifications made to an Internet browser to effect the rerouting of Internet message services according to the invention; and

FIG. 5 is a high level block diagram illustrating an exemplary embodiment of the invention based on a Siemens Hicom™ 150 AllServe™ PBX hub couple d to a corporate network and the PSTN.

### DETAILED DESCRIPTION

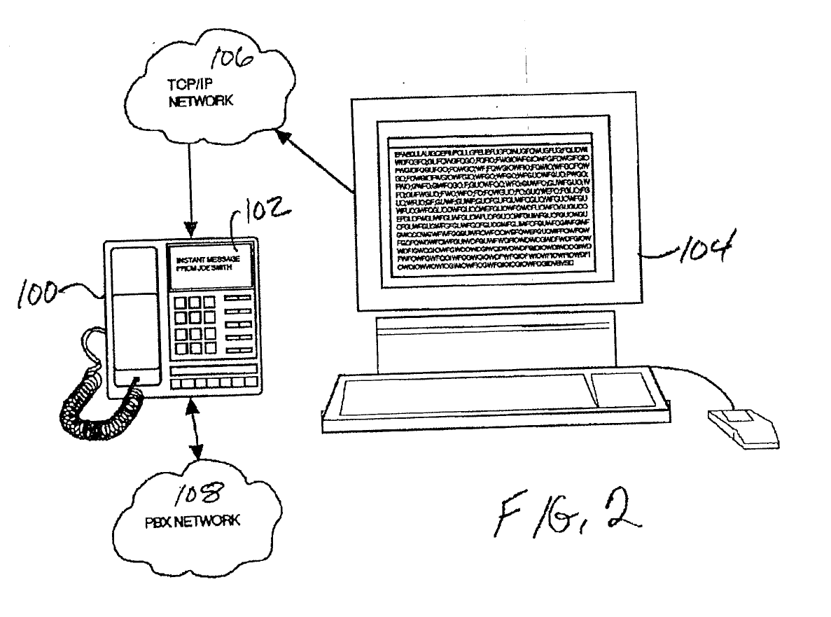

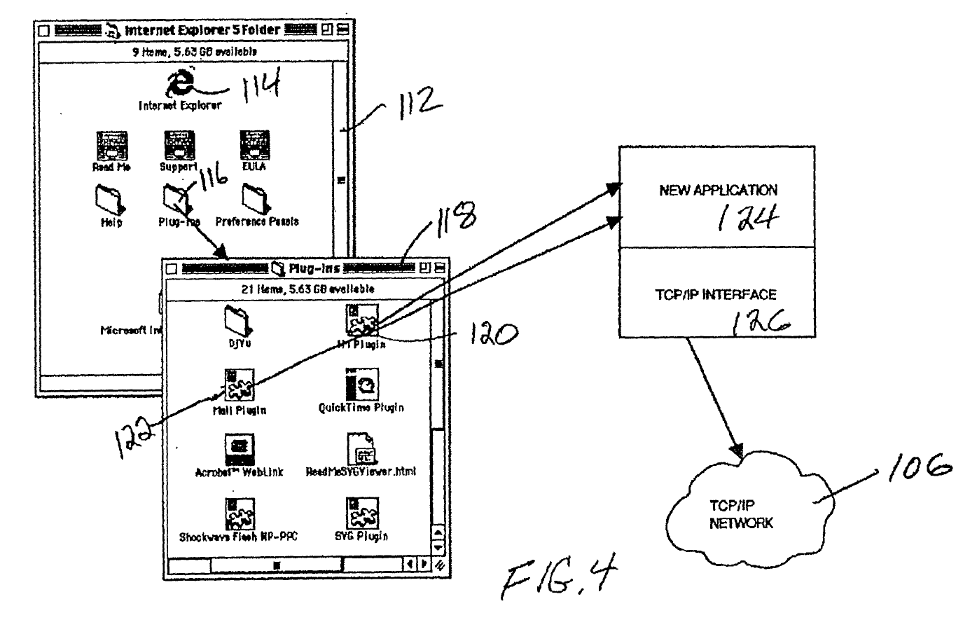

Turning now to FIG. 2, the apparatus of the invention includes at least one digital telephone 100 having an LCD display 102 and a computer workstation 104, both of which are coupled to the Internet 106. As used herein, the term “Internet” may be replaced with the term “TCP/IP” network which may or may not be connected to the Internet. For example, if Internet-type messaging is to be limited to a corporate “Intranet”, the TCP/IP network will not be (freely) connected to the Internet. Typically, however, the corporate TCP/IP network will be coupled (with few restrictions) to the public Internet. As shown in FIG. 2, the digital telephone 102 is also coupled to a corporate PBX 108. As described in more detail below with reference to FIG. 4 an application program is provided on the computer workstation 104 which redirects data received by the computer workstation to the display 102 of the digital telephone 100. The computer workstation 104 is provided with an Internet browser and an application that replaces the plug-in provided by the browser's vendor to handle the messaging features. The application uses the same port designated to the original browser plug-in. In addition to the normal features of the original plug-in, two new features are provided: the capability to login at the digital telephone 100 and the capability to resend the messaging service information packets to the digital telephone 100, after adding the digital phone addressing (received during login) to the original message.

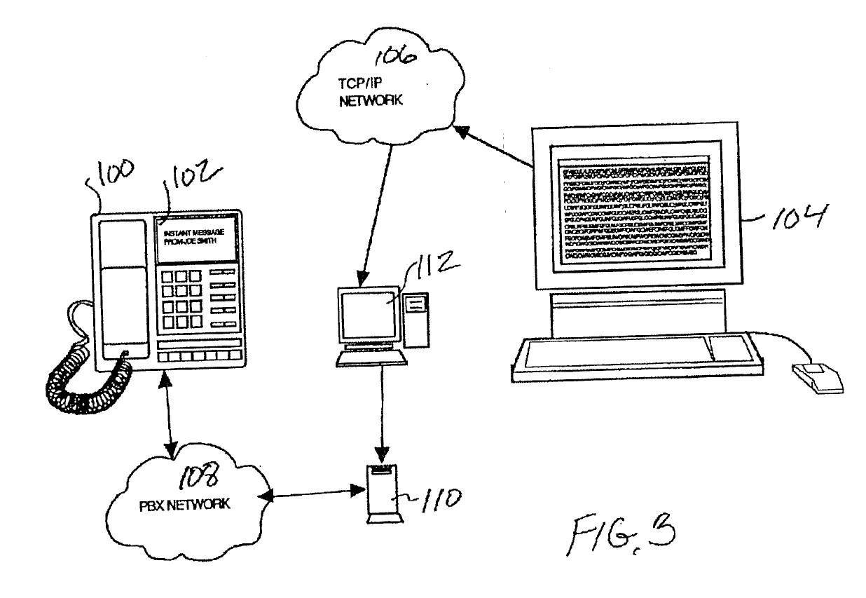

Turning now to FIG. 3, according to a second embodiment, a digital telephone 100 having an LCD display 102 is connected to a local PBX 108 and a computer workstation 104 is connected to the Internet 106. The local PBX hub 110 is connected to a server computer 112 which is connected to the Internet 106 and which provides Internet access over the PBX 108 via a proprietary interface. As described in more detail below with reference to FIG. 4, the computer workstation 104 is provided with an Internet browser and an application that replaces the plug-in provided by the browser's vendor to handle the messaging features. The application uses the same port designated to the original browser plug-in. In addition to the normal features of the original plug-in, two new features are provided: the capability to login at the digital telephone 100 via the PBX 108 and the capability to resend the messaging service information packets to the digital telephone 100, after adding the digital phone addressing (received during login) to the original message.

In both of the aforementioned embodiments, the PBX 108 “forwarding” feature can be applied to the messages displayed on the digital telephone's LCD display 102. Thus, Internet messages can be forwarded to any telephone or digital device connected to the PSTN anywhere in the world. Messages are forwarded via a “message mail” similar to the existing “voice mail”.

Referring now to FIG. 4, the Internet browser software provided in the computer workstation is illustrated in the directory 112. The directory 112 includes the browser 114 and a subdirectory 116 containing “plug-ins”. The contents of the subdirectory 116 are illustrated in part in the window 118. These plug-ins include an instant message plug-in 120 and a mail plug-in 122. According to the invention, these plug-ins are replaced with one or more applications 124 which provide additional functionality. The application(s) 124 uses the same port(s) 126 designated to the original browser plug-in(s). In addition to the normal features of the original plug-in(s), two new features are provided: the capability to login at the digital telephone via the PBX and the capability to resend the messaging service information packets to the digital telephone, after adding the digital phone addressing (received during login) to the original message.

According to the invention, any Internet messaging services may be provided to the digital telephone(s) via applications which replace plug-ins. These services include news groups, stock quotes, news headlines, weather reports, auction information as well as instant messages and electronic mail.

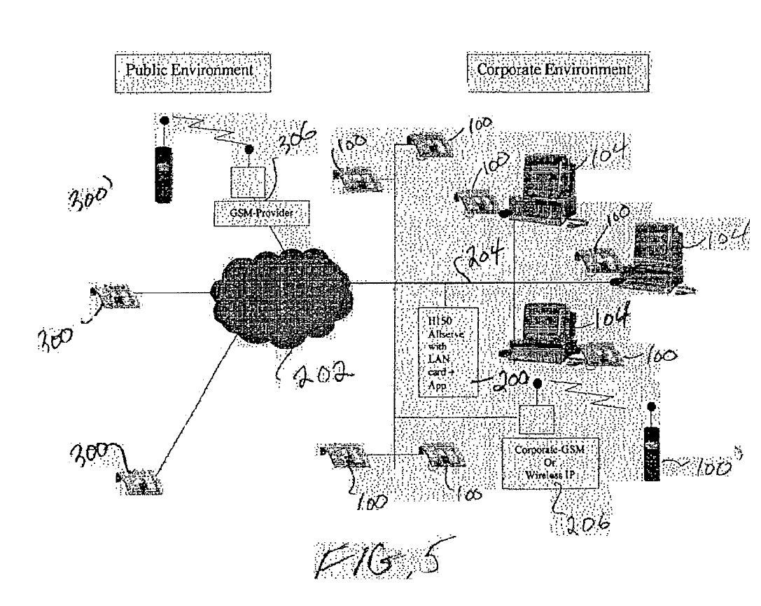

Referring now to FIG. 5, an exemplary embodiment of the invention employs the Siemens Hicom™ 150 AllServe™ PBX hub 200 which is coupled to the PSTN 202 and a corporate PBX network as well as a corporate data LAN shown collectively in FIG. 5 as 204. A plurality of digital phones 100 are connected to the corporate PBX and a plurality of computer workstations are coupled to the corporate LAN. The Hicom™ 150 hub 200 includes a LAN card for coupling the PBX to a TCP/IP LAN. A new application is installed in the Hicom™ 150 LAN card to receive TCP/IP packets related to the messaging services, decode and format the messages and send them to the corresponding Call Processing User Interface in the hub 200 for delivery to LCD equipped digital telephones 100 coupled to the PBX 204. The PBX Call Processing User Interface is enhanced to support the messaging service login procedure and to administer the display content presentation. This embodiment allows the Hicom™ 150 AllServe™ users to have access to Internet messaging services regardless of where they are actually located, as long as they are connected directly to the Hicom™ 150 AllServe™ in any of the networked corporate facilities including any digital phones 100′ coupled via corporate wireless service 206. In addition, remote digital telephones 300 coupled to the PSTN 202, including remote wireless devices 300′ served by a wireless provider 306 may connect remotely to the Hicom™ 150 AllServe™ via its fixed or mobile tele-working features.

There have been described and illustrated herein methods and apparatus for providing Internet text messages on the screen of a digital phone. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as so claimed.

What is claimed is:

1. A method for routing Internet-type messages from a computer workstation to a digital telephone having a display, said method comprising:
a) coupling the computer workstation to a TCP/IP network;
b) coupling the digital telephone to the TCP/IP network;
c) providing the computer workstation with a browser program which supports messaging plug-ins; and
d) providing custom messaging plug-ins for the browser program which allow the digital telephone to log on to the computer workstation and which forward messages to the digital telephone logged on to the workstation.

2. The method of claim 1, wherein:
the digital telephone and the computer workstation are directly coupled to said TCP/IP network.

3. The method of claim 1, wherein:
the TCP/IP network is the Internet.

4. The method of claim 1, wherein:
the TCP/IP network is a LAN.

5. The method of claim 4, further comprising:
e) coupling the computer workstation is coupled to the Internet.

6. The method of claim 1, wherein:
the digital telephone is coupled to the TCP/IP network via a PBX network coupled to a server computer coupled to the TCP/IP network.

7. The method of claim 1, wherein:
the digital telephone is coupled to the TCP/IP network via the PSTN coupled to a PBX network coupled to the TCP/IP network.

8. The method of claim 1, wherein:
the digital telephone is coupled to the TCP/IP network via a wireless connection to a PBX network coupled to the TCP/IP network.

9. The method of claim 1, wherein:
the digital telephone is coupled to the TCP/IP network via a wireless connection to the PSTN to a PBX network coupled to the TCP/IP network.

10. An apparatus for routing Internet-type messages from a computer workstation to a digital telephone having a display, said method comprising:
a) a computer workstation coupled to a TCP/IP network;
b) a digital telephone coupled to the TCP/IP network;
c) a browser program which supports messaging plug-ins installed on said computer workstation; and
d) at least one custom messaging program appearing as a plug-in to the browser program, said custom messaging program allowing said digital telephone to log on to said computer workstation and said custom messaging program forwarding messages to said digital telephone once it has logged on to said workstation.

11. The apparatus of claim 10, wherein:
said digital telephone and said computer workstation are directly coupled to said TCP/IP network.

12. The apparatus of claim 11, wherein:
the TCP/IP network is the Internet.

13. The apparatus of claim 11, wherein:
the TCP/IP network is a LAN.

14. The apparatus of claim 13, wherein:
said computer workstation is coupled to the Internet.

15. The apparatus of claim 11, wherein:
said digital telephone is coupled to the TCP/IP network via a PBX network coupled to a server computer coupled to the TCP/IP network.

16. The apparatus of claim 11, wherein:
said digital telephone is coupled to the TCP/IP network via the PSTN coupled to a PBX network coupled to the TCP/IP network.

17. The apparatus of claim 11, wherein:
said digital telephone is coupled to the TCP/IP network via a wireless connection to a PBX network coupled to the TCP/IP network.

18. The apparatus of claim 11, wherein:
said digital telephone is coupled to the TCP/IP network via a wireless connection to the PSTN to a PBX network coupled to the TCP/IP network.
